(19) United States
(12) Patent Application Publication
(10) Pub. No.: US 2005/0212789 A1
(43) Pub. Date: Sep. 29, 2005

(54) Display apparatus and method of controlling the same

(75) Inventor: Young kook Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRO-MECHANICS CO., LTD.

(21) Appl. No.: 11/085,476

(22) Filed: Mar. 22, 2005

(30) Foreign Application Priority Data
Mar. 23, 2004 (KR) 2004-0019704
Mar. 23, 2004 (KR) 2004-0019705

(51) Int. Cl. G09G 5/00

(52) U.S. Cl. 345/204

(57) ABSTRACT

A display apparatus including a signal input part into which a video signal from outside of the display apparatus is inputted, a power supply part, a display part, and a detecting part which detects whether the video signal is being inputted into the signal input part. A signal processing part processes the video signal into a signal which can be displayed by the display part. A switch regulates a supply of power from the power supply part to the signal processing part. A controller controls the switch based on a detected result of the detecting part to cut off the supply of power from the power supply part to the signal processing part when the video signal is not being inputted into the signal input part and to supply power from the power supply part to the signal processing part when the video signal is being inputted into the signal input part.

### CROSS-REFERENCE TO RELATED APPLICATIONS

This application claims the benefit of Korean Patent Application No. 2004-0019704, filed Mar. 23, 2004, in the Korean Intellectual Property Office and Korean Patent Application No. 2004-0019705, filed Mar. 23, 2004, in the Korean Intellectual Property Office, the disclosures of which are incorporated herein by reference.

### BACKGROUND OF THE INVENTION

1. Field of the Invention

Apparatuses and methods consistent with the present invention relate to a display apparatus and a method of controlling the same. More particularly, the present invention relates to a display apparatus which effectively addresses electric static discharge (ESD) without an ESD protection circuit, and a method of controlling the same.

2. Description of the Related Art

General display apparatuses comprise a signal input part into which a video signal from outside of the display apparatus is inputted, a signal processing part which processes the inputted video signal, and a display part which displays a picture based on a signal outputted from the signal processing part.

Display apparatuses often do not operate normally due to an electric static discharge (ESD), an electrical factor, which is impressed when the video signal is not being inputted into the signal input part and makes the signal processing part inoperable. This abnormality of the display apparatus is often referred to as latch-up or soft-fail.

FIG. 1. shows a control block diagram of the conventional display apparatus which comprises configurations to solve the above problem. As shown therein, the conventional display apparatus comprises a power supply part 1 to which power is supplied by an exterior power adapter or battery 7 and which supplies power to each circuit part, a display part 2, a signal input part 5 into which the video signal from outside of the display apparatus is inputted, and a signal processing part 3 which processes the video signal inputted from the signal input part 5 into a signal which can be displayed by the display part 2. Also included is an ESD protection circuit 6 which prevents the ESD impressed through the signal input part 5 from coming into the signal processing part 3 by bypassing the ESD, and a controller 4 which controls the signal processing part 3 to convert the video signal inputted by the signal input part 5 into a signal which can be displayed by the display part 2. Thus, the ESD protection circuit 6 prevents the latch-up or soft-fail by preventing the ESD from incoming into the signal processing part 3.

However, the ESD protection circuit 6 of the conventional display apparatus comprises a hardware circuit component such as diode. Accordingly, the manufacture cost of the display apparatus is increased.

### SUMMARY OF THE INVENTION

Accordingly, it is an aspect of the present invention to provide a display apparatus which can effectively solve problems related to electric static discharge (ESD) without using an ESD protection circuit, and a method of controlling the same.

According to an exemplary embodiment the foregoing and/or other aspects are achieved by providing a display apparatus comprising a signal input part into which a video signal from the outside of the display apparatus is inputted, a power supply part which supplies power to each circuit part, a display part, and a detecting part which detects whether the video signal is being inputted into the signal input part. Also included is a signal processing part which processes the video signal inputted from the signal input part into a signal which can be displayed by the display part, a switch which regulates a supplying of power from the power supply part to the signal processing part. A controller is provided which controls the switch based on a detected result of the detecting part to cut off the supply of power from the power supply part to the signal processing part when the controller determines that the video signal is not being inputted into the signal input part and to supply power from the power supply part to the signal processing part when the controller determines that the video signal is being inputted into the signal input part.

According to an another exemplary aspect of the invention, provided is a method of controlling a display apparatus having a signal input part into which a video signal from the outside of the display apparatus is inputted, a power supply part which supplies power to each circuit part, a display part, and a signal processing part which processes the video signal inputted from the signal input part into a signal which can be displayed by the display part. Included in the method is detecting whether the video signal is being inputted into the signal input part, and switching based on a detected result to cut off a supply of power from the power supply part to the signal processing part when the video signal being inputted into the signal input part is not detected and to supply power from the power supply part to the signal processing part when the video signal being inputted into the signal input part is detected.

According to an another exemplary aspect of the invention, a display apparatus is provided which comprises a signal input part into which a video signal from outside of the display apparatus is inputted, a power supply part which supplies power to each circuit part, a display part, and a detecting part which detects whether the video signal is being inputted into the signal input part. A signal processing part is provided which processes the video signal inputted from the signal input part into a signal which can be displayed by the display part, a switch which regulates a supply of power from the power supply part to the signal processing part, and a controller which controls the switch based on the detected result of the detecting part to reset the signal processing part when the controller determines that the video signal is being inputted into the signal input part by temporarily cutting off the supply of power from the power supply part to the signal processing part and then supplying power from the power supply part to the signal processing part.

According to an another exemplary aspect of the invention, provided is a method of controlling a display apparatus having a signal input part into which a video signal from outside of the display apparatus is inputted, a power supply part which supplies power to each circuit part, a display part, and a signal processing part which processes the video signal inputted from the signal input part into a signal which can be displayed by the display part. Included in the method is detecting whether the video signal is being inputted into the signal input part, and switching based on a detected result to reset the signal processing part when the video signal being inputted into the signal input part is detected by temporarily cutting off the supplying of power from the power supply part to the signal processing part and then supplying power from the power supply part to the signal processing part.

### BRIEF DESCRIPTION OF THE DRAWINGS

These and other objects and advantages of the present invention will be apparent and more readily appreciated from the following description of the exemplary embodiments, taken in conjunction with the accompanying drawing of which:

FIG. 1 is a control block diagram of a conventional display apparatus;

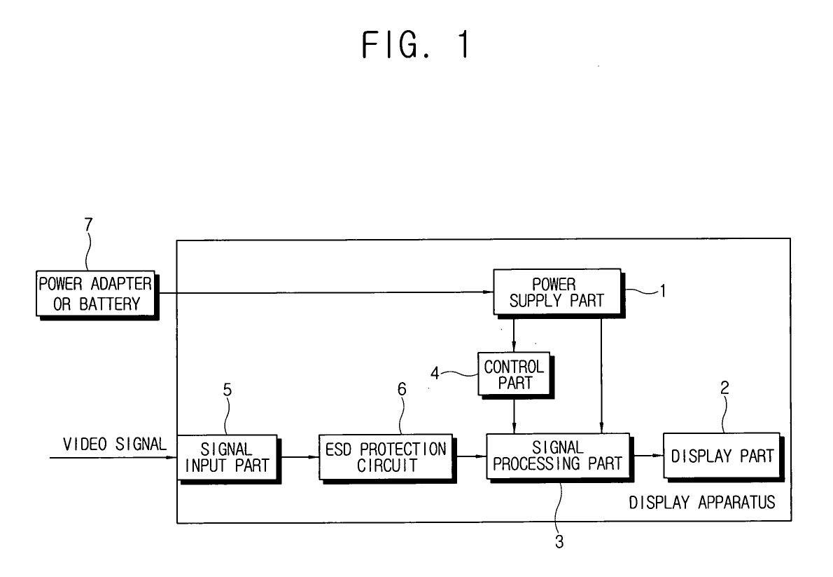

FIG. 2 is a control block diagram of a display apparatus according to a 1^{st} exemplary embodiment of the present invention;

FIG. 3 is a control block diagram of a display apparatus according to a 2^{nd} exemplary embodiment of the present invention;

FIG. 4 is a flow chart illustrating a method of controlling a display apparatus according to the 1^{st} embodiment of the present invention;

FIG. 5 is a flow chart illustrating the method of controlling a display apparatus according to the 2^{nd} embodiment of the present invention.

### DETAILED DESCRIPTION OF ILLUSTRATIVE, NON-LIMITING EMBODIMENTS

References will now be made in detail to exemplary embodiments of the present invention, examples of which are illustrated in the accompanying drawings, wherein like reference numerals refer to the like elements throughout. The embodiments are described below in order to explain the present invention by referring to the figures.

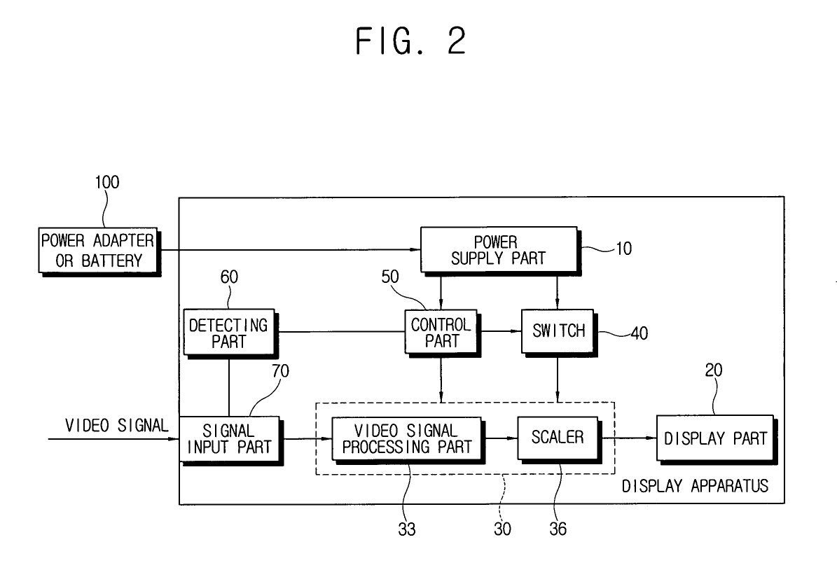

FIG. 2 shows a control block diagram of a display apparatus according to a 1^{st} exemplary embodiment of the present invention. As shown therein, the display apparatus according to the 1^{st} embodiment comprises a power supply part 10 to which power is supplied by an exterior power adapter or battery 100 and which supplies power to each circuit part, a display part 20, a signal input part 70 into which the video signal from the outside of the display apparatus is inputted, a signal processing part 30 which processes the video signal inputted from the signal input part 70 into a signal which can be displayed by the display part 20. A detecting part 60 is provided which detects whether the video signal is being inputted into the signal input part 70. A switch 40 regulates a supplying of power from the power supply part 10 to the signal processing part 30. A controller or control part 50 controls the switch 40 to cut off or supply power from the power supply part 10 to the signal processing part 30 based on a detected result of the detecting part 60.

The signal processing part 30 processes the video signal inputted from outside into the signal which can be displayed by the display part 20. Here the signal processing part 30 comprises a video signal processing part 33 which processes the video signal from the signal input part 70 and a scaler 36 which converts the signal from the video signal processing part 33 into a format which can be displayed by the display part 20.

If the video signal inputted through the signal input part 70 is a composite video banking sync (CVBS) video signal, the video signal processing part 33 may comprise a video decoder (not shown) which converts the CVBS video signal into a digital video signal. If the video signal inputted through the signal input part 70 is an RGB video signal, the video signal processing part 33 may comprise an A/D converter (not shown) which converts the RGB video signal into the digital video signal. If the video signal inputted through signal input part 70 is a digital video interface (DVI) signal, the video signal processing part 33 may comprise a transition-minimized differential signaling (TMDS) receiver (not shown) which decodes the DVI signal encoded by TMDS communication protocol. As above, the video signal processing part 33 may be provided in various forms according to the kind of inputted video signal.

Here the TMDS communication protocol is a digital transmission protocol supporting a DVI standard. If a computer encodes a digital signal through the TMDS communication protocol and outputs an encoded digital signal to the display apparatus, the display apparatus decodes the encoded digital signal and displays a decoded digital signal. In this manner, the digital data can be transferred without loss. The scaler 36 converts the signal outputted from the video signal processing part 33 into a format which can be displayed by the display part 20 according to the control of controller 50.

The controller 50 controls the signal processing part 30 to process and convert the video signal into the format which can be displayed by the display part 20. The controller 50 controls the switch 40 based on the detected result of the detecting part 60 to cut off the supplying of power from the power supply part 10 to the signal processing part 30 when the controller 50 determines that the video signal is not being inputted into the signal input part 70 and to supply power from the power supply part 10 to the signal processing part 30 when the controller 50 determines that the video signal is being inputted into the signal input part 70.

Here the controller 50 may comprise a microcomputer (not shown) which controls the signal processing part 30 and the switch 40. Although the 1^{st} exemplary embodiment of the present invention comprises the controller 50 and the detecting part 60 separately, the controller 50 and the detecting part 60 may be provided in various configurations without departing from the scope of the invention. For example, the controller 50 may directly detect whether the video signal is being inputted into the signal input part 70 without the detecting part 60.

Although the 1^{st} embodiment of the present invention controls the supplying of power to the signal processing part 30 without considering the kind of input video signal, it is possible to control the supplying of power to a corresponding circuit part according to the kind of input video signal. For example, if the input video signal is the RGB video signal, the controller 50 may control the supplying of power to an RGB video signal processing circuit part, such as the A/D converter (not shown), which converts the RGB video signal into the digital video signal.

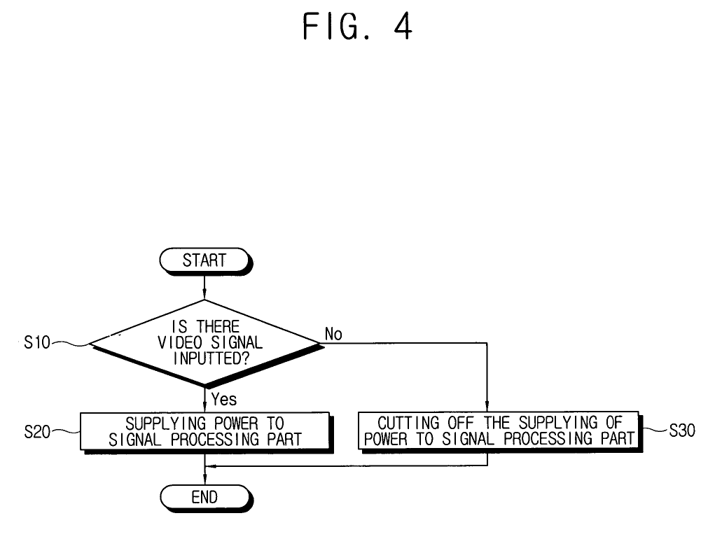

FIG. 4 shows a method of controlling the display apparatus according to the 1^{st} exemplary embodiment. First, the controller 50 determines whether the video signal is being inputted into the signal input part 70 based on the detected result of the detecting part 60 (S10). The controller 50 controls the switch 40 to supply power from the power supply part to the signal processing part when the controller 50 determines that the video signal is being inputted into the signal input part 70 at operation S20. Further the controller 50 controls the switch 40 to cut off the supplying of power from the power supply part 10 to the signal processing part 30 when the controller 50 determines that the video signal is not being inputted into the signal input part 70 at operation S30.

With the above configurations, the display apparatus according to the 1^{st} exemplary embodiment using hardware can reset the signal processing part 30 when the video signal from the signal input part 70 is inputted into the signal processing part 30 and the signal processing part 30 displays the signal on the display part 20 by cutting off the supplying of power to the signal processing part 30 when there is no video signal being input and supplying power to the signal processing part 30 when a video signal is input. Thus, the latch-up or the soft-fail, which occurs due to the impression of the ESD to the signal processing part 30 without inputting a video signal, can be prevented through a relatively simple configuration.

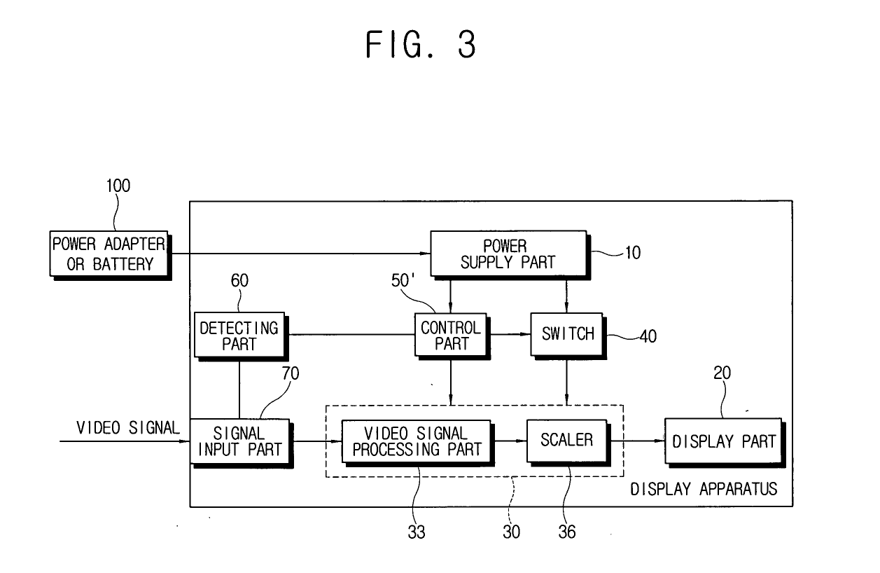

FIG. 3 shows a control block diagram of a display apparatus according to a 2^{nd} exemplary embodiment of the present invention. As shown therein, the display apparatus comprises a power supply part 10 to which power is supplied by an exterior power adapter or battery 100 and which supplies power to each circuit part, a display part 20, a signal input part 70 into which a video signal from the outside of the display apparatus is inputted. A signal processing part 30 is included which comprises a video signal processing part 33 to process the video signal inputted from outside of the display apparatus and a scaler 36 to convert a signal from the video signal processing part 33 into a format which can be displayed by the display part 20. A detecting part 60 detects whether the video signal is being inputted into the signal input part 70, and a switch 40 regulates a supply of power from the power supply part 10 to the signal processing part 30. A controller 50′ controls the switch to cut off or supply power from the power supply part 10 to the signal processing part 30 based on the detected result of the detecting part 60.

The controller 50′ controls the signal processing part 30 to process and convert the video signal into the format which can be displayed by the display part 20. The controller 50′ of the 2^{nd} exemplary embodiment controls the switch 40 to temporarily cut off the supply of power from the power supply part 10 to the signal processing part 30 and to then supply power from the power supply part 10 to the signal processing part 30 when the controller 50′ determines that the video signal is being inputted into the signal input part 70 on the basis of the detected result of the detecting part 60.

Here the controller 50′ may comprise a microcomputer (not shown) which controls the signal processing part 30 and the switch 40. Although the 2^{nd} embodiment of the present invention comprises the controller 50′ and the detecting part 60 separately, the controller 50′ and the detecting part 60 may be provided in various configurations without departing from the scope of the present invention. For example, the controller 50′ may directly detect whether the video signal is being inputted into the signal input part 70 without the detecting part 60.

Further the video signal processing part 33 may be provided in various forms according to the kind of video signal being input, such as a video decoder, a A/D converter, or TMDS receiver which disclosed in the 1^{st} embodiment.

Although the 2^{nd} embodiment of the present invention controls the supplying of power to the signal processing part 30 without considering the kind of the input video signal, it is possible for the controller 50′ to control a corresponding circuit part according to the kind of input video signal, which is disclosed in the 1^{st} embodiment.

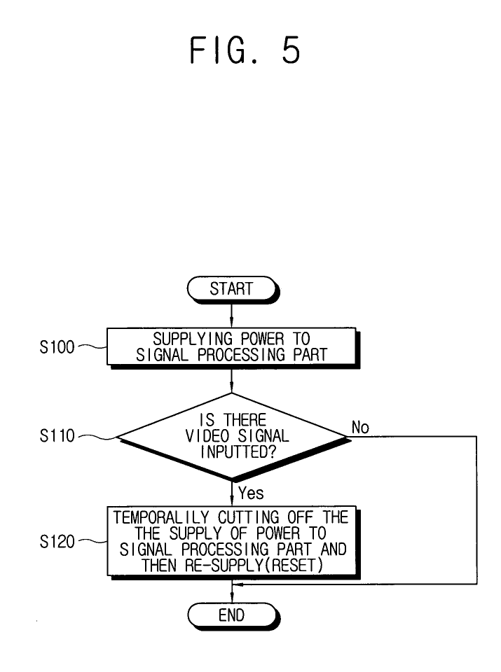

FIG. 5 shows a method of controlling the display apparatus according to the 2^{nd} exemplary embodiment of the present invention. Once the display apparatus starts to operate, power is supplied to each circuit part of the display apparatus including the signal processing part 30 (S 100). Then the controller 50′ determines whether the video signal is being inputted into the signal input part 70 based on the detected result of the detecting part 60 (S 110). The controller 50′ controls the switch 40 to keep supplying power from the power supply part 10 to the signal processing part 30 when the controller 50′ determines that the video signal is not being inputted into the signal input part 70. At operation S120, if the controller 50′ determines that the video signal is being inputted into the signal part 70, the controller 50′ controls the switch 40 to temporarily cut off the supplying of power from the power supply part 10 to the signal processing part 30 and then supply power from the power supply part 10 to the signal processing part 30.

With the above configurations, the display apparatus according to the 2^{nd} exemplary embodiment using hardware can reset the signal processing part 30 when the video signal from the signal input part 70 is inputted into the signal processing part 30 and the signal processing part 30 displays the video signal on the display part 20 by temporarily cutting off the supplying of power from the power supply part 10 to the signal processing part 30 and then supplying power from the power supply part 10 to the signal processing part 30. Thus, the latch-up or the soft-fail, which occurs due to the impression of ESD to the signal processing part 30 without the input video signal, can be prevented through relatively simple configuration.

Although a few embodiments of the present invention have been shown and described, it will be appreciated by those skilled in the art that changes may be made in these aspects without departing from the principles and spirit of the invention, the scope of which is defined in the appended claims and their equivalents

1. A display apparatus comprising:
a signal input part into which a video signal from the outside of the display apparatus is inputted;
a power supply part which supplies power;
a display part;
a detecting part which detects whether the video signal is inputted into the signal input part;
a signal processing part which processes the video signal inputted from the signal input part into a signal which can be displayed by the display part;
a switch which regulates a supply of power from the power supply part to the signal processing part; and
a controller which controls the switch based on a detection of the detecting part to cut off the supply of power from the power supply part to the signal processing part when the controller determines that the video signal is not being inputted into the signal input part and to supply power from the power supply part to the signal processing part when the controller determines that the video signal is being inputted into the signal input part.

2. A method of controlling a display apparatus having a signal input part into which a video signal from the outside of the display apparatus is inputted, a power supply part which supplies power, a display part, and a signal processing part which processes the video signal inputted from the signal input part into a signal which can be displayed by the display part, the method comprising:
detecting whether the video signal is being inputted into the signal input part; and
switching based on the detecting to cut off a supply of power from the power supply part to the signal processing part when the video signal being inputted into the signal input part is not detected and to supply power from the power supply part to the signal processing part when the video signal being inputted into the signal input part is detected.

3. A display apparatus comprising:
a signal input part into which a video signal from the outside of the display apparatus is inputted;
a power supply part which supplies power;
a display part;
a detecting part which detects whether the video signal is being inputted into the signal input part;
a signal processing part which processes the video signal inputted from the signal input part into a signal which can be displayed by the display part;
a switch which regulates a supply of power from the power supply part to the signal processing part; and
a controller which controls the switch based on a detection of the detecting part to reset the signal processing part when the controller determines that the video signal is being inputted to the signal input part to temporarily cut off a supply of power from the power supply part to the signal processing part and to then supply power from the power supply part to the signal processing part.

4. A method of controlling a display apparatus having a signal input part into which a video signal from the outside of the display apparatus is inputted, a power supply part which supplies power, a display part, and a signal processing part which processes the video signal inputted from the signal input part into a signal which can be displayed by the display part comprising:
detecting whether the video signal is being inputted to the signal input part; and
switching based on the detecting to reset the signal processing part when the video signal being inputted into the signal input part is detected by temporarily cutting off a supply of power from the power supply part to the signal processing part and to then supply power from the power supply part to the signal processing part.

5. The display apparatus of claim 1, wherein the power supply part supplies power to each part of the display apparatus.

6. The method of controlling a display apparatus of claim 2, wherein the power supply part supplies power to each part of the display apparatus.

7. The display apparatus of claim 3, wherein the power supply part supplies power to each part of the display apparatus.

8. The method of controlling a display apparatus of claim 4, wherein the power supply part supplies power to each part of the display apparatus.
